(19) United States
(12) Patent Application Publication
(10) Pub. No.: US 2026/0214534 A1
(43) Pub. Date: Jul. 23, 2026

(54) MEASUREMENT GAP CONFIGURATION FOR L1 MEASUREMENT IN LTM

(71) Applicant: QUALCOMM Incorporated, San Diego, CA (US)

(72) Inventors: Fang YUAN, Beijing (CN); Yan ZHOU, San Diego, CA (US); Jelena DAMNJANOVIC, Del Mar, CA (US)

(21) Appl. No.: 19/137,268

(22) PCT Filed: Feb. 15, 2023
(86) PCT No.: PCT/CN2023/076055

§ 371 Date: Jun. 9, 2025

(51) Int. Cl. H04W 36/00; H04W 36/08

(52) U.S. Cl. CPC H04W 36/0088; H04W 36/08

(57) ABSTRACT

A method for wireless communication at a user equipment (UE) and related apparatus are provided. In the method, the UE obtains an indication including one or more layer 1 (L1) inter-frequency reference signals (RSs) for lower-layer triggered mobility (LTM). The indication includes an L1 measurement gap configuration indicative of at least one L1 measurement gap associated with the one or more L1 inter-frequency RSs. The UE further performs one or more L1 measurements based on the one or more L1 inter-frequency RSs. The method enables various measurement gap configurations for inter-frequency RS for LTM. It enhances the flexibility of inter-frequency LTM measurements and improves the efficiency of wireless communication.

### TECHNICAL FIELD

The present disclosure relates generally to communication systems, and more particularly, to wireless communication with measurement gap configuration for layer 1 (L1) measurement in lower-layer triggered mobility (LTM).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory and at least one processor coupled to the memory. Based at least in part on information stored in the memory, the at least one processor may be configured to obtain an indication including one or more L1 inter-frequency reference signals (RSs) for LTM, where the indication includes an L1 measurement gap configuration indicative of at least one L1 measurement gap associated with the one or more L1 inter-frequency RSs; and perform one or more L1 measurements based on the one or more L1 inter-frequency RSs.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to transmit an indication including one or more L1 inter-frequency RSs for LTM, where the indication includes an L1 measurement gap configuration indicative of at least one L1 measurement gap associated with the one or more L1 inter-frequency RSs; and obtain one or more L1 measurements based on the one or more L1 inter-frequency RSs.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example beam management.

FIG. 4B is a diagram illustrating an example inter-cell beam management.

FIG. 5 is a diagram illustrating an example cell configuration.

FIG. 6 is a diagram illustrating a system model of an example cell configuration.

FIG. 7 is a diagram illustrating an example measurement gap pattern.

FIG. 8 is a diagram illustrating an example measurement gap for measurements for LTM.

FIG. 9 is a diagram illustrating an example L1 measurement gap configuration in accordance with various aspects of the present disclosure.

FIG. 10A is a diagram illustrating example measurement gaps in accordance with various aspects of the present disclosure.

FIG. 10B is a diagram illustrating example measurement gaps in accordance with various aspects of the present disclosure.

FIG. 11A is a diagram illustrating example measurement gaps in accordance with various aspects of the present disclosure.

FIG. 11B is a diagram illustrating example measurement gaps in accordance with various aspects of the present disclosure.

FIG. 11C is a diagram illustrating example measurement gaps in accordance with various aspects of the present disclosure.

FIG. 12 is a call flow diagram illustrating a method of wireless communication in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a UE in accordance with various aspects of the present disclosure.

FIG. 15 is a flowchart illustrating methods of wireless communication at a network entity in accordance with various aspects of the present disclosure.

FIG. 16 is a flowchart illustrating methods of wireless communication at a network entity in accordance with various aspects of the present disclosure.

FIG. 17 is a diagram illustrating an example of a hardware implementation for an example apparatus and/or network entity.

FIG. 18 is a diagram illustrating an example of a hardware implementation for an example network entity.

### DETAILED DESCRIPTION

Various aspects relate generally to communication systems. Some aspects more specifically relate to wireless communication with measurement gap configuration for L1 measurement in LTM. In some examples, a UE may obtain an indication including one or more L1 inter-frequency RSs for LTM, where the indication includes an L1 measurement gap configuration indicative of at least one L1 measurement gap associated with the one or more L1 inter-frequency RSs; and perform one or more L1 measurements based on the one or more L1 inter-frequency RSs.

Particular aspects of the subject matter described in this disclosure can be implemented to realize one or more of the following potential advantages. In some examples, by configuring an indication including one or more L1 inter-frequency RSs for LTM for a UE, where the indication includes an L1 measurement gap configuration indicative of at least one L1 measurement gap associated with the one or more L1 inter-frequency RSs, the described techniques can be used to enable various measurement gap configurations for inter-frequency RS for LTM. It enhances the flexibility of inter-frequency LTM measurements and improves the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

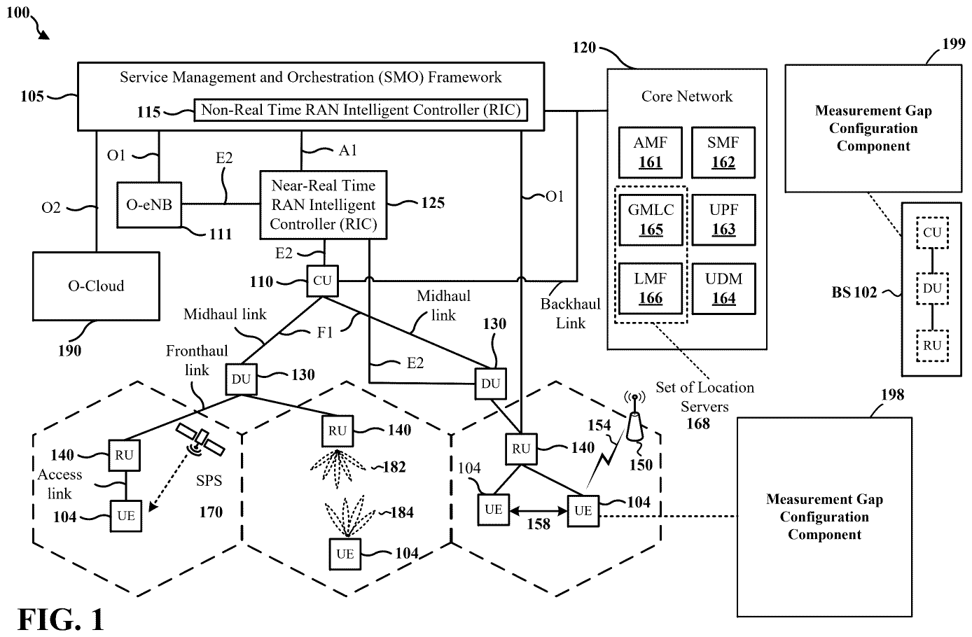

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a measurement gap configuration component 198. The measurement gap configuration component 198 may be configured to obtain an indication including one or more L1 inter-frequency RSs for LTM, where the indication includes an L1 measurement gap configuration indicative of at least one L1 measurement gap associated with the one or more L1 inter-frequency RSs; and perform one or more L1 measurements based on the one or more L1 inter-frequency RSs. In certain aspects, the base station 102 may include a measurement gap configuration component 199. The measurement gap configuration component 199 may be configured to transmit an indication including one or more L1 inter-frequency RSs for LTM, where the indication includes an L1 measurement gap configuration indicative of at least one L1 measurement gap associated with the one or more L1 inter-frequency RSs; and obtain one or more L1 measurements based on the one or more L1 inter-frequency RSs. Although the following description may be focused on 5G NR, the concepts described herein may be applicable to other similar areas, such as LTE, LTE-A, CDMA, GSM, and other wireless technologies.

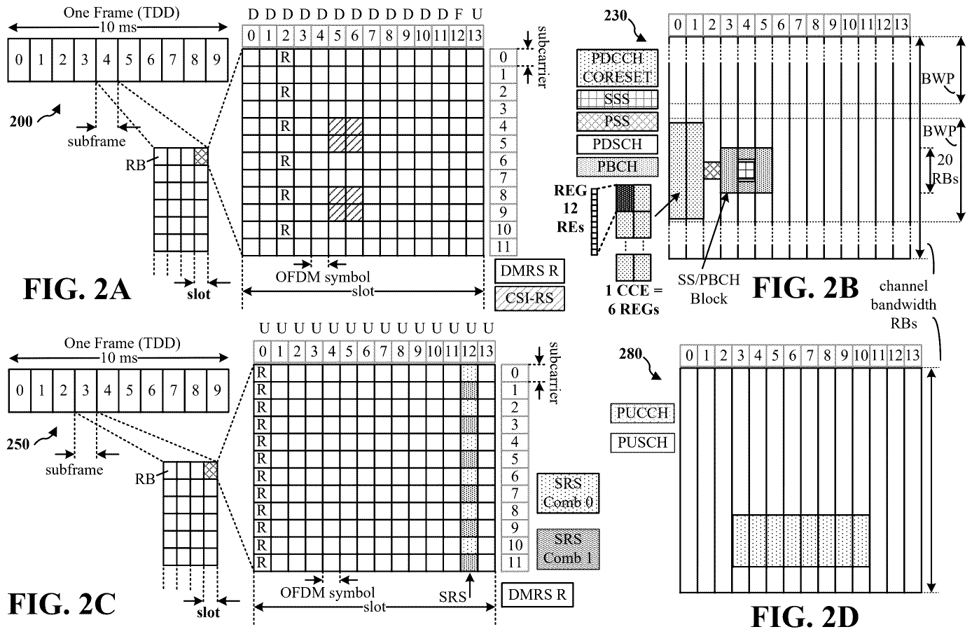

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ *15} kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

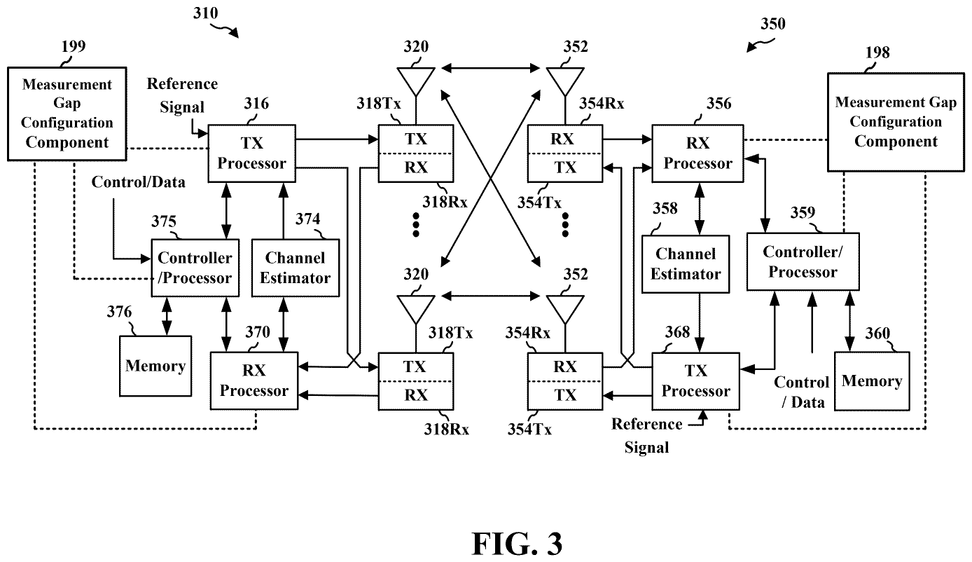

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the measurement gap configuration component 198 of FIG. 1.

At least one of the TX processor 316, the RX processor 370, and the controller/processor 375 may be configured to perform aspects in connection with the measurement gap configuration component 199 of FIG. 1.

A network may be in communication with a UE based on one or more beams (spatial filters). For example, a base station of the network may transmit a beamformed signal to a UE in one or more directions that correspond with one or more beams. The base station and the UE may perform beam training to determine the best receive and transmit beam directions for the base station and the UE.

In response to different conditions, beams may be switched. For example, a TCI state change may be transmitted by a base station so that the UE may switch to a new beam for the TCI state. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication. A TCI state may include quasi-co-location (QCL) information that the UE can use to derive timing/frequency error and/or transmission/reception spatial filtering for transmitting/receiving a signal.

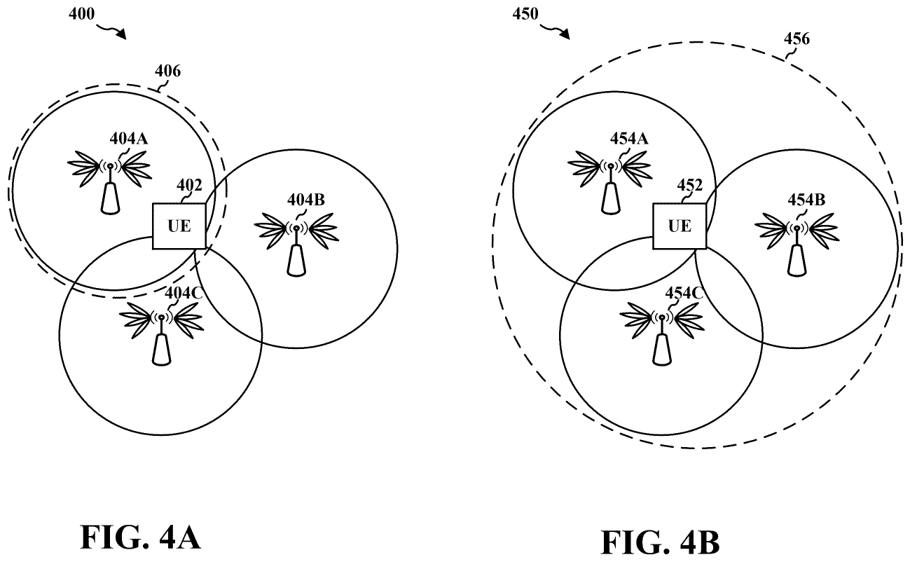

Different procedures for managing and controlling beams may be collectively referred to as “beam management.” The process of selecting a beam to switch to for data channels or control channels may be referred to as “beam selection.” In some wireless communication systems, beam selection for data channels or control channels may be limited to beams within the same physical cell identifier (ID) (PCI). A PCI may be associated with a TRP. FIG. 4A is a diagram 400 illustrating an example of beam management. As illustrated in FIG. 4A, for a UE 402, beam selection 406 may be limited to beams within the PCI 404A and beams associated with the PCI 404B and the PCI 404C may not be used. As an example, each of the PCI 404A, the PCI 404B, and the PCI 404C may be associated with a different TRP.

By way of example, a UE may encounter two types of mobility-cell-level mobility and beam-level mobility (which may be beam-based mobility). For cell-level mobility, a UE may experience an inter-base station handover. In some wireless communication systems, for beam-level mobility, as previously explained, switching of beams may occur within the same base station.

In some wireless communication systems, inter-cell beam management may be based on beam-based mobility where the indicated beam may be from a TRP with different PCI with regard to the serving cell. Benefits of inter-cell beam management based on beam-based mobility may include more robustness against blocking, more opportunities for higher rank for subscriber data management (SDM) across different cells, and in general more efficient communication between a UE and the network. FIG. 4B is a diagram 450 illustrating an example of inter-cell beam management. As illustrated in FIG. 4B, for a UE 452, beam selection 456 may be based on beams within the PCI 454A and beams associated with the PCI 454B and the PCI 454C. As an example, each of the PCI 454A, the PCI 454B, and the PCI 454C may be associated with a different TRP.

As an example, inter-cell beam management based on beam-based mobility may be facilitated by L1 and/or L2 (L1/L2) signaling, such as UE-dedicated channels/RSs, which may be associated with a switch to a TRP with different PCI according to downlink control information (DCI) or medium access control (MAC) control element (MAC-CE) based unified TCI update. As used herein, such mobility may be referred to as L1/L2 mobility (lower-layer triggered mobility (LTM)).

In some aspects, the network may configure a set of cells for L1/L2 mobility or LTM. The set of cells for L1/L2 mobility may be referred to as L1/L2 mobility configured cell set or an LTM configured cell set. A subset of the L1/L2 mobility configured cell set may be activated (e.g., with L1 or L2 control signaling) and may be referred to as an L1/L2 mobility activated cell set (which may also be referred to as an L1/L2 activated mobility cell set or LTM activated cell set). The subset of the L1/L2 mobility configured cell set that is not activated or that is indicated to be deactivated may be referred to as an L1/L2 mobility deactivated cell set or a deactivated L1/L2 mobility cell set or an LTM deactivated cell set. The L1/L2 mobility activated cell set may be a group of cells in the L1/L2 mobility configured cell set that are activated and may be readily used for data and control transfer. The L1/L2 mobility deactivated cell set (which may be an L1/L2 mobility candidate cell set) may be a group of cells in the configured set that is configured for the UE yet deactivated (e.g., not used for data/control transfer until activated) and may be activated by L1/L2 signaling. Once activated, a deactivated cell may be used for data and control transfer. The configuration and maintenance of multiple candidate cells may allow for a quicker application of configurations for the candidate cells, and the activated set of cells may provide for dynamic switching among the candidate serving cells (e.g., including a special cell (SpCell) and SCell) based on L1 or L2 signaling.

The procedures of L1/L2 based inter-cell mobility or LTM are applicable to many scenarios. These scenarios may include standalone CA and NR-DC cases with serving cell changing within one CG, intra-DU cases and intra-CU inter-DU cases (applicable for standalone and CA, with no new RAN interface expected), intra-frequency and inter-frequency cases, FR1 and FR2 cases. In these scenarios, the source and target cells may be synchronized or non-synchronized.

For mobility management of the activated cell set, L1/L2 signaling may be used to activate/deactivate cells in the L1/L2 mobility configured cell set and to select beams within the activated cells (of the activated cell set). As the UE moves, cells from the L1/L2 mobility configured cell set may be deactivated and activated by L1/L2 signaling based on signal quality (e.g., based on measurements), loading, or the like. Example measurements may include cell coverage measurements represented by Radio Signal Received Power (RSRP), and quality represented by Radio Signal Received Quality (RSRQ), or other measurements that the UE performs on signals from the base station. In some aspects, the measurements may be L1 measurements, such as one or more of an RSRP, an RSRQ, a received signal strength indicator (RSSI), or a signal-to-interference plus noise ratio (SINR) measurement of various signals, such as an SSB, a PSS, an SSS, a broadcast channel (BCH), a DM-RS, CSI-RS, or the like.

In some aspects, all cells in the L1/L2 mobility configured cell set may belong to the same DU and the cells may be on the same or different carrier frequencies. Cells in the L1/L2 mobility configured cell set may cover a mobility area.

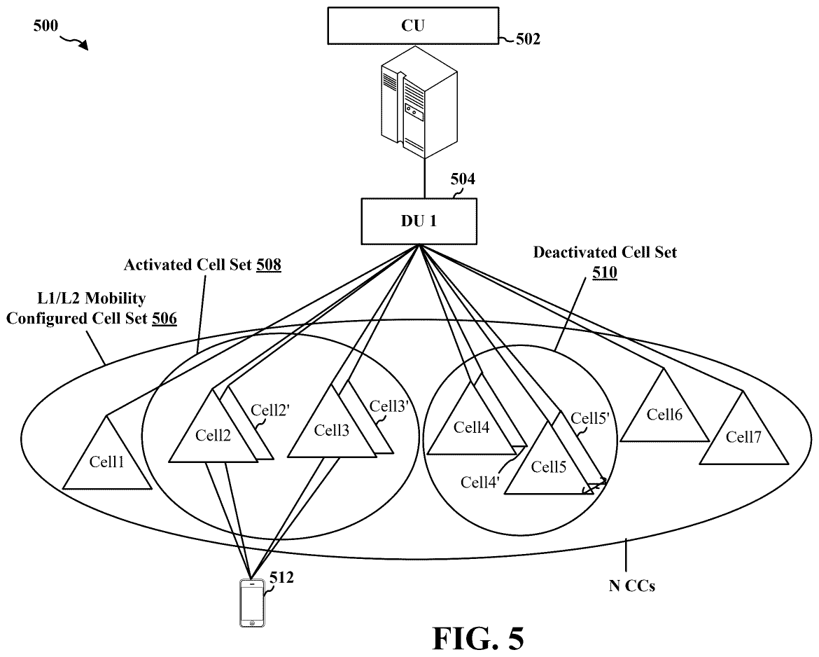

FIG. 5 is a diagram 500 illustrating an example of cell configuration. As illustrated in FIG. 5, a CU 502 (which may correspond to a component of a base station such as a gNB) may be associated with a first DU 504 (and other DUs). An L1/L2 mobility configured cell set 506 may be associated with the first DU 504 and may include an L1/L2 mobility activated cell set 508 and an L1/L2 mobility deactivated cell set 510. The L1/L2 mobility configured cell set 506 may also include one or more cells not in the current L1/L2 mobility activated cell set 508 or the current L1/L2 mobility deactivated cell set 510. For example, at a given time, the L1/L2 mobility activated cell set 508 may include a first subset of the L1/L2 mobility configured cell set, and the L1/L2 mobility deactivated cell set 510 may include a second, non-overlapping subset of the L1/L2 mobility configured cell set. There may remain one or more cells that are in the L1/L2 mobility configured cell set that are not in the first set subset (e.g., activated) or the second subset (e.g., deactivated). A UE 512 may use the cells in the L1/L2 mobility activated cell set 508 for data channel and control channel communications.

A UE may be provided with a subset of L1/L2 mobility deactivated cells (candidate cell set) that the UE may autonomously choose to add to the L1/L2 mobility activated cell set. For example, the UE may add cells in the subset of L1/L2 mobility deactivated cells to the L1/L2 mobility activated cell set based on measurements (e.g., measured channel quality), loading, or the like. In some aspects, each of the RUs could have multi-component carrier (CC) (N CCs) support (where each CC is a cell). In some aspects, activation or deactivation may be performed for groups of carriers (cells). For PCell management, L1/L2 signaling may be used to set the PCell out of the configured options within the activated cell set. In some aspects, L3 mobility may be used for PCell change (L3 handover) when a new PCell is not from the activated cell set for L1/L2 mobility. As an example, RRC signaling may be used to update the set of cells for L1/L2 mobility at L3 handover. In some aspects, L1/L2 mobility configured cells may be associated with a PCell configuration without being the PCell. The PCell configuration may be activated and one of the L1/L2 mobility activated cells (e.g., in an L1/L2 mobility activated cell set) may be activated based on L1/L2 signaling to become a PCell. In some aspects, L1/L2 mobility deactivated cells (e.g., in an L1/L2 mobility deactivated cell set) may support L1 measurements to facilitate sufficient beam management, timing synchronization, power control, or the like. For L1/L2 mobility deactivated cells, measurement reporting may be done on an activated cell.

A network node (e.g., a base station) may change a SpCell for a UE using a layer 3 (L3) handover (e.g., using radio resource control (RRC) signaling). However, L3 handovers may be time-consuming and/or inefficient. A network node that utilizes the improved L1/L2 signaling scheme is able to change one or more cells for a UE in a more rapid manner in comparison to L3 (RRC) based approaches. In an example, a UE receives an L1 or L2 mobility cell configuration for a set of cells for L1 or L2 inter-cell mobility. The set of cells may include multiple cells, and each cell in the set of cells is able to be activated or deactivated for data and/or control transfer using L1 or L2 signaling. The UE receives L1 or L2 signaling indicating multiple activated cells, and activates one or more cells in the multiple activated cells in a priority order for the data and/or control transfer using L1 or L2 signaling. Via the aforementioned L1 or L2 signaling, one or more cells, including SpCell and SCell, are able to be activated and/or deactivated in a manner that avoids RRC-based signaling. As a result, the cells may be activated and/or deactivated in a more rapid manner in comparison to RRC-based signaling. Additionally, the cells may be activated in a priority order to further facilitate more efficient and robust mobility management.

A base station may configure a UE, e.g., in RRC signaling, with a set of cells for L1/L2 mobility. The set of cells may be referred to as an L1/L2 mobility configured set. A subset of the cells in the configured set may be activated and can be used for data and control transfer between the UE and the network. The subset of activated cells may be referred to as the L1/L2 mobility activated cell set. A subset of the L1/L2 mobility configured set may be deactivated and may be referred to as the L1/L2 mobility deactivated set. The L1/L2 deactivated set of cells can be activated for the UE by L1/L2 signaling from the network.

In conditional handover, a set of candidate cells (including cell ID, system information, etc.) and conditions for handover may be configured in advance via RRC. When the configured condition is met for one of the configured candidate cells, the UE may initiate the handover procedure by transmitting PRACH toward the candidate cell. The handover completion may be notified to the previous serving cell by the new serving cell. DL/UL channel between the UE and the new cell might not be immediately usable for high speed/volume traffic due to the lack of, for example, channel state information between the UE and the new cell.

For enhanced mobility, the UE may be configured with a set of candidate cells (including cell ID, system information, etc.) in advance, and the UE may be expected to keep performing L1 and L3 measurements for the configured candidate cells. A handover toward a specific cell among the preconfigured candidate cells will be initiated via L1 and/or L2 messages. The handover allows the DL/UL channel over the new link to be immediately usable for high speed/volume traffic as soon as the handover procedure is completed. As a part of the fast handover procedure, communication is improved with a seamless UL power control mechanism. Otherwise, DL/UL transmission/reception may be delayed except for PRACH and Random-Access Response (RAR) for UL power control initialization, even when Timing Advance (TA) for the new cell is obtained by other means.

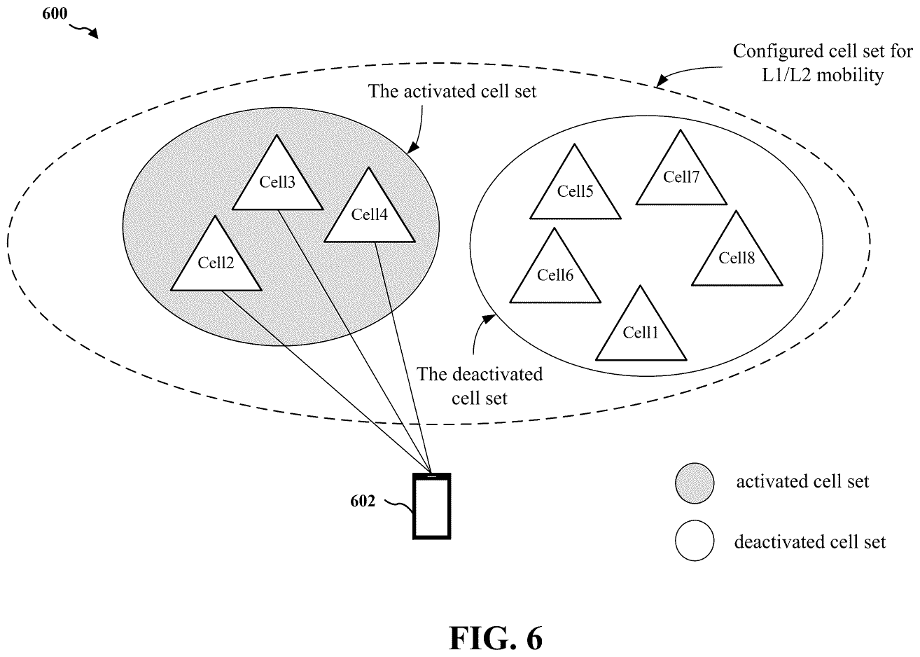

FIG. 6 is a diagram 600 illustrating a system model of an example cell configuration. As shown in FIG. 6, a UE 602 may be configured with a set of cells (Cell1, . . . , Cell8) for L1/L2 mobility. The set of cells may be configured through radio resource control (RRC) signaling. The set of cells may be on the same frequencies, and the existing mechanism of carrier aggregation (CA) may be utilized to enable L1/L2 mobility. Cells in the configured set may be further characterized into two groups: activated cells and deactivated cells. The activated cells are serving cells that are currently active and can be used for data and control transfer. The deactivated cells are serving cells that are currently deactivated (and hence have no active data or control communication with the UE 602) but can be quickly activated through L1/L2 signaling to the UE from the network.

The UE 602 may be a mobile device and may be moving while communicating with the cells in the configured cell set. L1/L2 signaling may be used to activate/deactivate cells in the set and to select beams within the activated cells. For example, as the UE 602 moves, the serving cell may change based on, for example, the UE's location and measurement reports using L1/L2 singling. A group of cells may be activated at one time. L1/L2 signaling may be used to set the PCell out of the configured PCell options within the activated cell set. L3 mobility may be used for PCell change (L3 handover) to a new PCell is not from the configured cell set for L1/L2 mobility, and RRC signaling may update the set of cells for L1/L2 mobility at L3 handover.

Example aspects presented herein provide methods and apparatus for measurement gap configurations for L1 measurement in LTM. In wireless communication, a measurement gap is a time duration reserved for a UE to perform measurements on DL signals (e.g., measurements on the signal quality of the DL signals). The signal to be measured within a measurement gap may come from, for example, a candidate cell (e.g., a non-serving cell) of the UE, and the candidate cell may be operating on a frequency or a subcarrier-spacing that is the same as or different from that of the serving cell of the UE. For example, the UE may measure SSBs of the neighboring cells within a measurement gap. Depending on the operating frequency band and the type of the candidate cell, the UE may perform intra-frequency (for a candidate cell operating on the same frequency band as the serving cell), inter-frequency (for a candidate cell operating on a different frequency band than the serving cell), or inter-RAT measurements (for an inter-RAT candidate cell) within a measurement gap. A UE may not transmit or receive the other signals within a measurement gap.

A network may configure a measurement gap for a UE through RRC signaling (e.g., using MeasGapConfig Information Element (IE)). The configuration for a measurement gap may indicate characteristics of the measurement gap, which may include the gap time offset (the relative starting position (subframe) of the gap), the gap length (e.g., 3, 6, or 10 ms), and the periodicity of the measurement gap (e.g., 20, 40, or 80 ms).

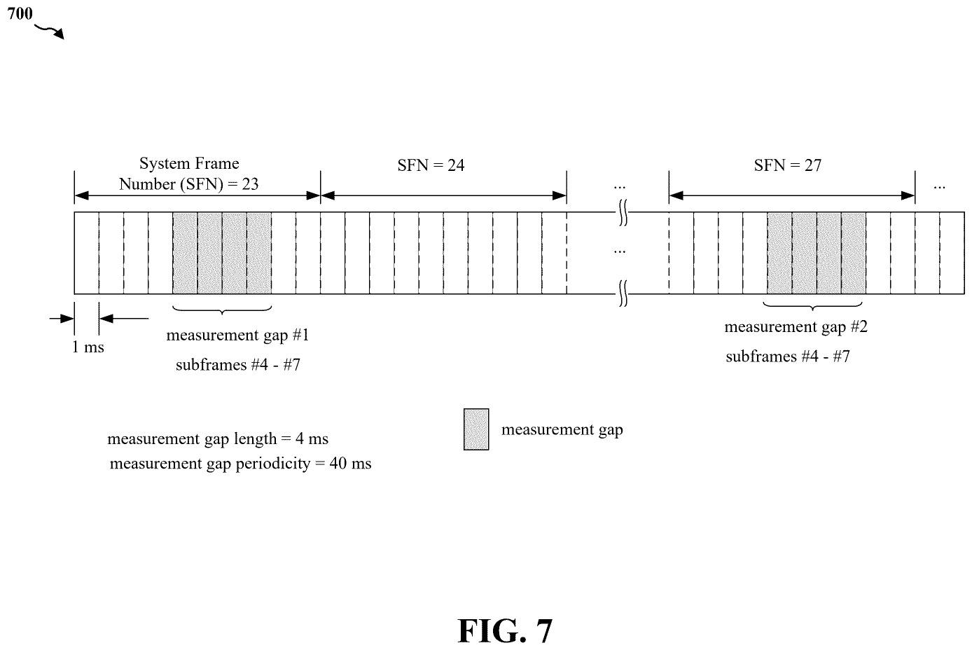

FIG. 7 is a diagram 700 illustrating an example measurement gap pattern. The example measurement gap pattern of FIG. 7 may include multiple measurement gaps, each occupying, for example, four subframes (subframes #4-#7). The gap length of each measurement gap is 4 ms (assuming each subframe is 1 ms), and the periodicity of the measurement gap is 40 ms.

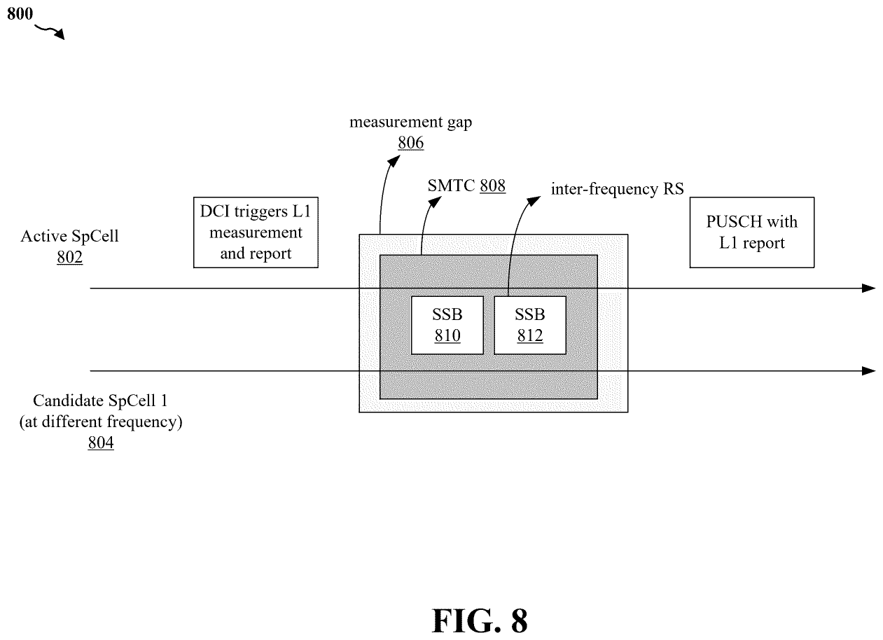

The measurement gap may be used for the measurements of a candidate cell in L1/L2 mobility or LTM. FIG. 8 is a diagram 800 illustrating an example measurement gap for LTM measurements. As shown in FIG. 8, DCI may trigger an L1 measurement and report, which may indicate a UE to measure a candidate SpCell 804, which may operate on a different frequency band than the active SpCell 802. To perform the L1 measurement, the UE may be configured with a measurement gap 806. The measurement gap 806 may include one or more measurement windows, such as window 808 configured by SSB-based measurement timing configuration (SMTC), which may be referred to as an SMTC window. The UE may be further configured with one or more RSs (e.g., SSB 810 and SSB 812) within the one or more measurement windows (e.g., window 808). The UE may perform measurements on the one or more RSs (e.g., SSB 810 and SSB 812) and report the measurement results in PUSCH, for example.

Inter-frequency resources in L1 measurement may include a time gap for RF tuning (e.g., the adjustment of transmission characteristics for measurements performed on a different frequency band), and existing L3 measurement gap configuration may not be efficient for L1 measurement. For example, the L1 measurement RSs may be a small subset of the L3 measurement RSs, and the L1 measurements may be performed on an on-demand basis, and thus the associated measurement gap may also be on demand. Hence, the measurement gap configured for L3 measurements may not be suitable for L1 measurements. Example aspects present herein provide measurement gap configurations for inter-frequency RS measurement for candidate cells in LTM. In some examples, the measurement gap configuration may be based on the RRC configuration structure with some modifications, and the pre-validation of the candidate cell's RRC configurations may not be necessary.

In some aspects, for L1 measurement in LTM, the L1 inter-frequency RSs in a resource set associated with an L1 CSI report configured in the active cell can be associated with at least one L1 measurement gap. In some examples, if there is no actual measurement in the time occasion of the measurement gap, the UE may ignore the L1 measurement gap. In this disclosure, an “inter-frequency RS” may refer to an RS associated with an inter-frequency measurement. An “L1 inter-frequency RS” may refer to an inter-frequency RS associated with an L1 measurement.

In some aspects, the L1 measurement gap configuration may be based on an L3 measurement gap configuration. The L1 measurement gap configuration may be a configuration for measurement gaps for L1 measurements in layer 1 (L1) or lower layers. For example, an L1 measurement gap configuration may include configurations for the gap length (represented by, for example, parameter Mgl), the gap time offset (represented by, for example, parameter gapOffset), and the gap periodicity (represented by, for example, parameter Mgrp). In some aspects, the L1 measurement gap configuration may further include a gap ID (represented by, for example, parameter measGapId) and a gap priority if multiple gaps are configured.

In some aspects, for the indication of a measurement gap for an L1 inter-frequency measurement, which is used for a CSI measurement in layer 1, the measurement gap identifier (ID) may be associated with an L1 resource set for inter-frequency RSs. In some aspects, for the indication of a measurement gap for L1 inter-frequency measurement, the measurement gap may be associated with an RS configuration (e.g., the RRC configuration of “SSB-MTC-LTM”, or the SSB-MTC-LTM configuration), which may contain a measured inter-frequency RS. In one example, each RS configuration (e.g., in the SSB-MTC-LTM configuration) may be associated with one measurement gap ID. In another example, different RS configurations (e.g., in different SSB-MTC-LTM configurations) may be associated with the same gap ID. In another example, different RS configurations (e.g., different SSB-MTC-LTM configurations) may be respectively associated with different gap IDs.

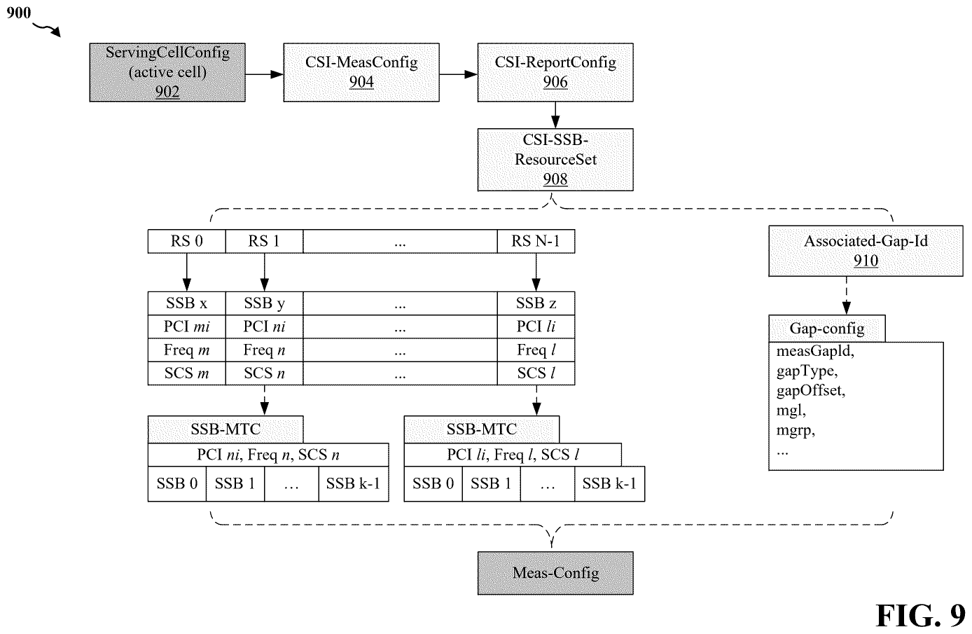

FIG. 9 is a diagram 900 illustrating an example L1 measurement gap configuration in accordance with various aspects of the present disclosure. As shown in FIG. 9, a UE may be configured with a serving cell. The serving cell's configuration for active cell (e.g., ServingCellConfig 902) may include a configuration for CSI measurements (e.g., CSI-MeasConfig 904), which may further include a CSI report configuration (e.g., CSI-ReportConfig 906). The CSI report configuration may indicate an L1 measurement resource set (e.g., CSI-SSB-ResourceSet 908). The L1 measurement resource set (e.g., CSI-SSB-ResourceSet 908) may be configured with multiple RSs (e.g., RS 0, RS 1, . . . , RS N−1) and a measurement gap ID (e.g., Associated-Gap-Id 910) associated with the measurement resource set (e.g., CSI-SSB-ResourceSet 908).

The measurement gap ID may refer to a measurement gap configuration (e.g., Gap-config), which may include configurations for gap type, gap offset, gap length, and gap periodicity, etc. Through RRC configuration, each of the RSs (e.g., RS 0, RS 1, . . . , RS N−1) configured in the measurement resource set (e.g., CSI-SSB-ResourceSet 908) may be configured with an RS configuration, which may include configurations for an SSB (e.g., SSB x), a Physical Cell Index (PCI) (e.g., PCI mi), associated frequency information (e.g., Freq m), and associated subcarrier spacing (SCS) information (e.g., SCS m). Different RSs may have different RS configurations.

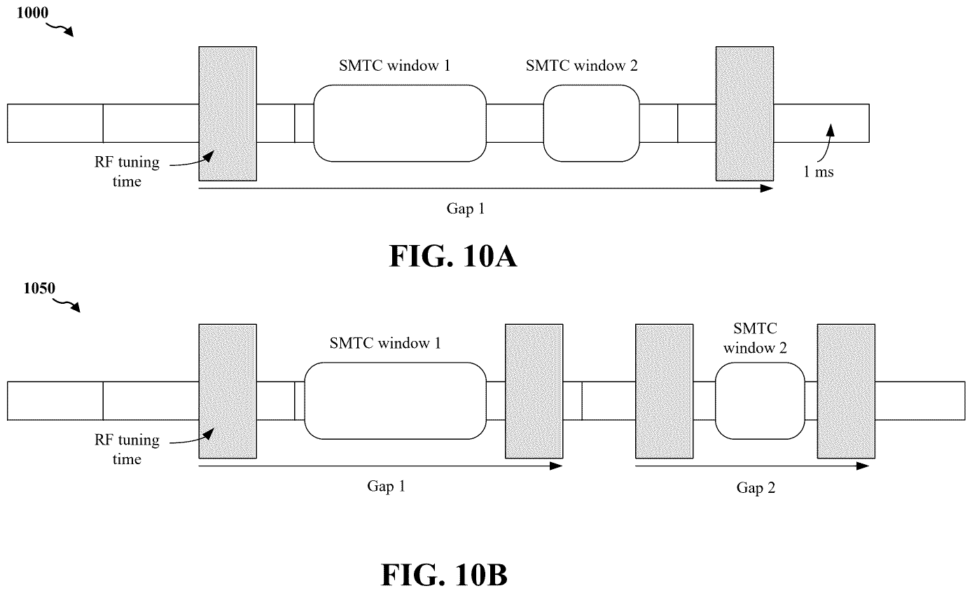

FIG. 10A is a diagram 1000 illustrating an example measurement gap in accordance with various aspects of the present disclosure. As shown in FIG. 10A, a UE may be configured with multiple SMTC windows (e.g., SMTC window 1 and SMTC window 2), within which the UE may be configured with SSBs for measurements. If the multiple SMTC windows are associated with the same resource set, the UE may be configured with a measurement gap (e.g., Gap 1) that contains all the multiple SMTC windows.

FIG. 10B is a diagram 1050 illustrating an example measurement gap in accordance with various aspects of the present disclosure. As shown in FIG. 10B, a UE may be configured with one measurement gap for one RS configuration that contains one RS. For example, the UE may be configured with one measurement gap (e.g., Gap 1) for one SMTC window (e.g., SMTC window 1), which may contain one RS (e.g., SSB). The UE may be further configured with another measurement gap (e.g., Gap 2) for another SMTC window (e.g., SMTC window 2), which may contain one RS (e.g., SSB).

In some aspects, a time gap may be used for L1 inter-frequency measurements, and the measured RS may be contained in the associated time gap. The time gap may be implemented with respect to the RSs in various schemes.

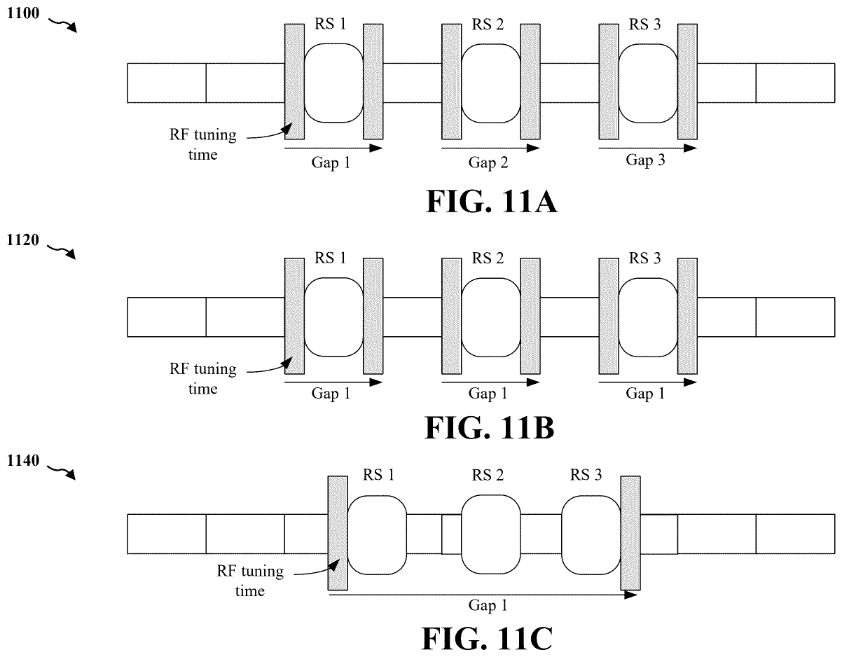

In some examples, the time gap may include multiple individual gaps. Each individual gap may be configured for one RS of multiple RSs, and different RSs may have different associated gap lengths for the associated individual gap. FIG. 11A is a diagram 1100 illustrating example measurement gaps in accordance with various aspects of the present disclosure. For example, referring to FIG. 11A, the time gap may include multiple individual gaps (e.g., Gap 1, Gap 2, and Gap 3). Each individual gap may be configured for one RS (e.g., RS 1, RS 2, or RS 3) of multiple RSs, and different RSs may have different associated gap lengths (the lengths of Gap 1, Gap 2, and Gap 3 may be different) for the associated individual gap.

In some examples, the time gap may include multiple individual gaps. A common gap length may be configured (or by default) for all RSs in an RS set, and different RSs may have the same gap length for the associated individual gap. FIG. 11B is a diagram 1120 illustrating example measurement gaps in accordance with various aspects of the present disclosure. For example, referring to FIG. 11B, for multiple individual gaps (e.g., the individual gaps for RS 1, RS 2, and RS 3), a common gap length may be configured (or by default) for all RSs in an RS set, and different RSs (RS 1, RS 2, and RS 3) may have the same gap length for the associated individual gap.

In some examples, the time gap may include multiple individual gaps. Each individual gap may be configured for an RS set, (e.g., per CSI-SSB-ResourceSet). The RS set may contain all the measured RSs. FIG. 11C is a diagram 1140 illustrating an example measurement gap in accordance with various aspects of the present disclosure. For example, referring to FIG. 11C, if multiple RSs (e.g., RS 1, RS 2, and RS 3) belong to the same RS set, an individual gap (e.g., Gap 1) may be configured for all the RSs (RS 1, RS 2, and RS 3 combined) in the RS set.

In some examples, the time gap may include multiple individual gaps. An individual gap may be configured on per frequency band and/or per SCS. For example, referring to FIG. 11C, if multiple RSs (e.g., RS 1, RS 2, and RS 3) are associated with the same frequency band or the same SCS, an individual gap (e.g., Gap 1) may be configured for all the RSs (RS 1, RS 2, and RS 3 combined).

The configuration for the time gap may include the length of the time gap (which may be represented by parameter mgl, for example). The configuration for the time gap may further include the offset (which may be represented by parameter gapOffset, for example) for the time gap and the periodicity (which may be represented by parameter mgrp, for example) for the time gap.

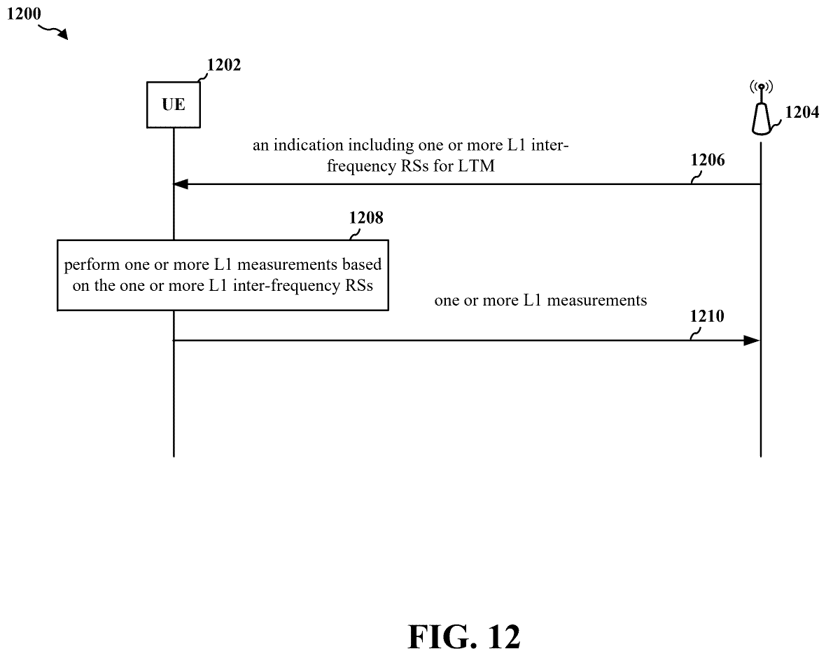

FIG. 12 is a call flow diagram 1200 illustrating a method of wireless communication in accordance with various aspects of this present disclosure. Although aspects are described for a base station 1204, the aspects may be performed by a base station in aggregation and/or by one or more components of a base station 1204 (e.g., such as a CU 110, a DU 130, and/or an RU 140).

As shown in FIG. 12, a UE 1202 may obtain an indication including one or more L1 inter-frequency RSs for LTM. The indication may include an L1 measurement gap configuration indicative of at least one L1 measurement gap associated with the one or more L1 inter-frequency RSs. The UE 1202 may obtain the indication from the base station 1204. For example, referring to FIG. 11A, the indication may include one or more L1 inter-frequency RSs for LTM (RS 1, RS 2, and RS 3), and the indication may include an L1 measurement gap configuration indicative of at least one L1 measurement gap (e.g., Gap 1, Gap 2, and Gap 3) associated with the one or more L1 inter-frequency RSs (e.g., RS 1, RS 2, and RS 3).

At 1208, the UE 1202 may perform one or more L1 measurements based on the one or more L1 inter-frequency RSs. For example, referring to FIG. 8, the UE may perform one or more L1 measurements based on the one or more L1 inter-frequency RSs (e.g., SSB 810 and SSB 812). Referring to FIG. 11A, the UE may perform one or more L1 measurements based on the one or more L1 inter-frequency RSs (e.g., RS 1, RS 2, and RS 3).

At 1210, the UE 1202 may transmit the one or more L1 measurements to the base station 1204. For example, referring to FIG. 8, the UE may transmit the one or more L1 measurements to the base station 1204 in PUSCH.

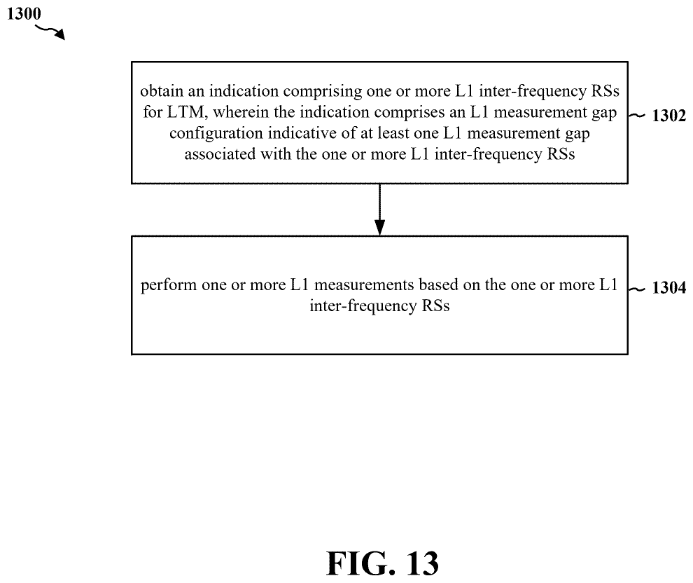

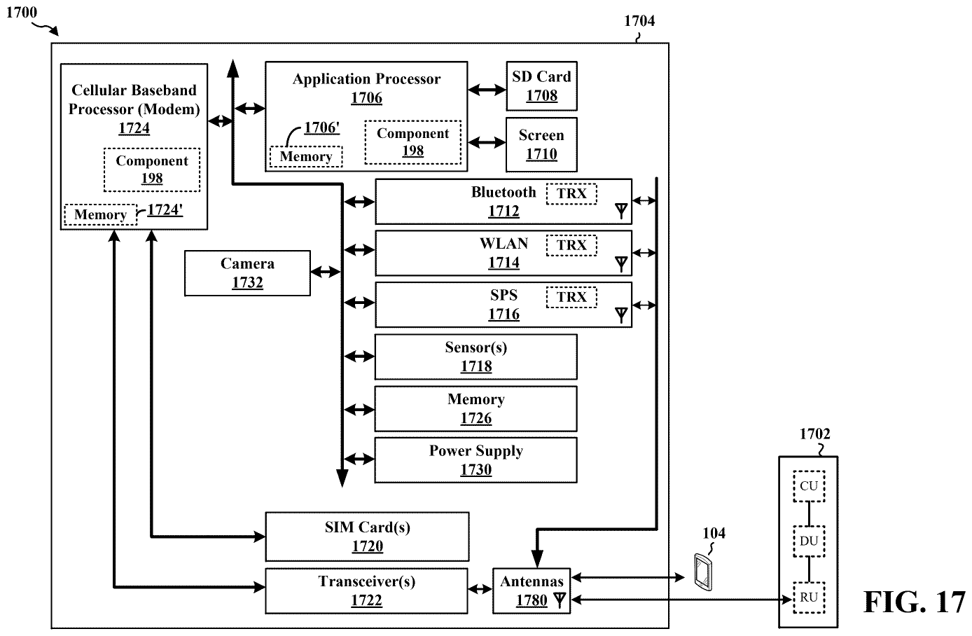

FIG. 13 is a flowchart 1300 illustrating methods of wireless communication at a UE in accordance with various aspects of the present disclosure. The method may be performed by a UE. The UE may be the UE 104, 350, 1202, or the apparatus 1704 in the hardware implementation of FIG. 17. The method enables various measurement gap configurations for inter-frequency RS for LTM. It enhances the flexibility of inter-frequency LTM measurements and improves the efficiency of wireless communication.

As shown in FIG. 13, at 1302, the UE may obtain an indication including one or more L1 inter-frequency RSs for LTM. The indication may include an L1 measurement gap configuration indicative of at least one L1 measurement gap associated with the one or more L1 inter-frequency RSs. The network entity may be a base station, or a component of a base station, in the access network of FIG. 1 or a core network component (e.g., base station 102, 310, 1204; or the network entity 1702 in the hardware implementation of FIG. 17). FIGS. 9, 10A, 10B, 11A, 11B, 11C, and 12 illustrate various aspects of the steps in connection with flowchart 1300. For example, referring to FIG. 12, the UE 1202 may obtain, at 1206, an indication including one or more L1 inter-frequency RSs for LTM. Referring to FIG. 11A, the indication may include one or more L1 inter-frequency RSs for LTM (e.g., RS 1, RS 2, and RS 3), and the indication may include an L1 measurement gap configuration indicative of at least one L1 measurement gap (e.g., Gap 1, Gap 2, and Gap 3) associated with the one or more L1 inter-frequency RSs (e.g., RS 1, RS 2, and RS 3). Referring to FIG. 11C, the indication may include an L1 measurement gap configuration indicative of at least one L1 measurement gap (e.g., Gap 1) associated with the one or more L1 inter-frequency RSs (e.g., RS 1, RS 2, and RS 3). In some aspects, 1302 may be performed by the measurement gap configuration component 198.

At 1304, the UE may perform one or more L1 measurements based on the one or more L1 inter-frequency RSs. For example, referring to FIG. 12, the UE 1202 may perform, at 1208, one or more L1 measurements based on the one or more L1 inter-frequency RSs. Referring to FIG. 8, the UE may perform one or more L1 measurements based on the one or more L1 inter-frequency RSs (e.g., SSB 810 and SSB 812). Referring to FIG. 11A, the UE may perform one or more L1 measurements based on the one or more L1 inter-frequency RSs (e.g., RS 1, RS 2, and RS 3). In some aspects, 1304 may be performed by the measurement gap configuration component 198.

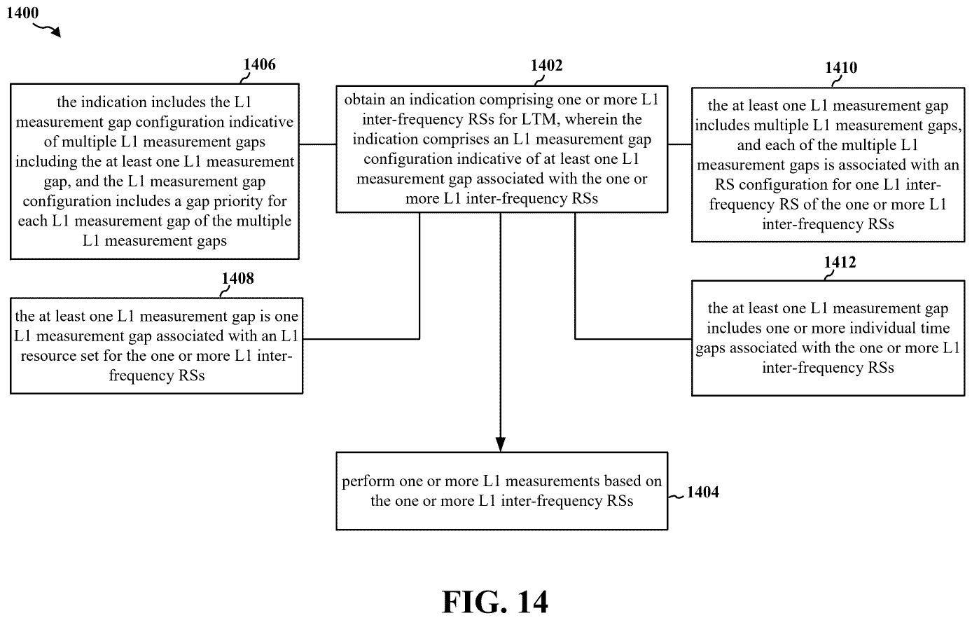

FIG. 14 is a flowchart 1400 illustrating methods of wireless communication at a UE in accordance with various aspects of the present disclosure. The method may be performed by a UE. The UE may be the UE 104, 350, 1202, or the apparatus 1704 in the hardware implementation of FIG. 17. The method enables various measurement gap configurations for inter-frequency RS for LTM. It enhances the flexibility of inter-frequency LTM measurements and improves the efficiency of wireless communication.

As shown in FIG. 14, at 1402, the UE may obtain an indication including one or more L1 inter-frequency RSs for LTM. The indication may include an L1 measurement gap configuration indicative of at least one L1 measurement gap associated with the one or more L1 inter-frequency RSs. The network entity may be a base station, or a component of a base station, in the access network of FIG. 1 or a core network component (e.g., base station 102, 310, 1204; or the network entity 1702 in the hardware implementation of FIG. 17). FIGS. 9, 10A, 10B, 11A, 11B, 11C, and 12 illustrate various aspects of the steps in connection with flowchart 1400. For example, referring to FIG. 12, the UE 1202 may obtain, at 1206, an indication including one or more L1 inter-frequency RSs for LTM. Referring to FIG. 11A, the indication may include one or more L1 inter-frequency RSs for LTM (e.g., RS 1, RS 2, and RS 3), and the indication may include an L1 measurement gap configuration indicative of at least one L1 measurement gap (e.g., Gap 1, Gap 2, and Gap 3) associated with the one or more L1 inter-frequency RSs (e.g., RS 1, RS 2, and RS 3). Referring to FIG. 11C, the indication may include an L1 measurement gap configuration indicative of at least one L1 measurement gap (e.g., Gap 1) associated with the one or more L1 inter-frequency RSs (e.g., RS 1, RS 2, and RS 3). In some aspects, 1402 may be performed by the measurement gap configuration component 198.

At 1404, the UE may perform one or more L1 measurements based on the one or more L1 inter-frequency RSs. For example, referring to FIG. 12, the UE 1202 may perform, at 1208, one or more L1 measurements based on the one or more L1 inter-frequency RSs. Referring to FIG. 8, the UE may perform one or more L1 measurements based on the one or more L1 inter-frequency RSs (e.g., SSB 810 and SSB 812). Referring to FIG. 11A, the UE may perform one or more L1 measurements based on the one or more L1 inter-frequency RSs (e.g., RS 1, RS 2, and RS 3). In some aspects, 1404 may be performed by the measurement gap configuration component 198.

In some aspects, the L1 measurement gap configuration may be based on an L3 measurement gap configuration, and the L1 measurement gap configuration may include one or more of: the gap length for the at least one L1 measurement gap; the gap time offset for the at least one L1 measurement gap; the gap periodicity for the at least one L1 measurement gap; and the gap ID for the at least one L1 measurement gap. For example, referring to FIG. 9, the L1 measurement gap configuration may include one or more of: the gap length (e.g., mgl) for the at least one L1 measurement gap; the gap time offset (e.g., gapOffset) for the at least one L1 measurement gap; the gap periodicity (e.g., mgrp) for the at least one L1 measurement gap; and the gap ID (e.g., Associated-Gap-Id 910) for the at least one L1 measurement gap.

In some aspects, at 1406, the indication may include the L1 measurement gap configuration indicative of multiple L1 measurement gaps including the at least one L1 measurement gap. The L1 measurement gap configuration may include a gap priority for each L1 measurement gap of the multiple L1 measurement gaps. For example, referring to FIG. 10B, the indication may include the L1 measurement gap configuration indicative of multiple L1 measurement gaps (e.g., Gap 1 and Gap 2), and the L1 measurement gap configuration may include a gap priority for each L1 measurement gap of the multiple L1 measurement gaps (e.g., the priority for Gap 1 and the priority for Gap 2). In some aspects, 1406 may be performed by the measurement gap configuration component 198.

In some aspects, at 1408, the at least one L1 measurement gap may be one L1 measurement gap associated with an L1 resource set for the one or more L1 inter-frequency RSs. For example, referring to FIG. 9, the at least one L1 measurement gap (e.g., the gap referenced by Associated-Gap-Id 910) may be one L1 measurement gap associated with an L1 resource set (e.g., the CSI-SSB-ResourceSet 908) for the one or more L1 inter-frequency RSs (e.g., RS 0, RS 1, . . . , RS N−1). In some aspects, 1408 may be performed by the measurement gap configuration component 198.

In some aspects, at 1410, the at least one L1 measurement gap may include multiple L1 measurement gaps, and each of the multiple L1 measurement gaps may be associated with an RS configuration for one L1 inter-frequency RS of the one or more L1 inter-frequency RSs. For example, referring to FIG. 11A, the at least one L1 measurement gap may include multiple L1 measurement gaps (e.g., Gap 1, Gap 2, and Gap 3), and each of the multiple L1 measurement gaps may be associated with an RS configuration for one L1 inter-frequency RS of the one or more L1 inter-frequency RSs (e.g., RS 1, RS 2, and RS 3). In some aspects, 1410 may be performed by the measurement gap configuration component 198.

In some aspects, each of the multiple L1 measurement gaps may be respectively associated with one gap ID of multiple gap IDs, and the multiple L1 measurement gaps may be associated with the same gap ID. For example, referring to FIG. 11B, each of the multiple L1 measurement gaps (e.g., gaps associated with RS 1, RS 2, and RS 3) may be respectively associated with one gap ID (e.g., the ID for Gap 1) of multiple gap IDs, and the multiple L1 measurement gaps (e.g., gaps associated with RS 1, RS 2, and RS 3) may be associated with the same gap ID (e.g., the ID for Gap 1).

In some aspects, each of the multiple L1 measurement gaps may be respectively associated with one gap ID of multiple gap IDs, and the multiple L1 measurement gaps may be associated with different gap IDs. For example, referring to FIG. 11A, each of the multiple L1 measurement gaps (e.g., gaps associated with RS 1, RS 2, and RS 3) may be respectively associated with one gap ID (e.g., IDs for Gap 1, Gap 2, and Gap 3) of multiple gap IDs, and the multiple L1 measurement gaps may be associated with different gap IDs (e.g., Gap 1 for the gap associated with RS 1, Gap 2 for the gap associated with RS 2, and Gap 3 for the gap associated with RS 3).

In some aspects, at 1412, the at least one L1 measurement gap may include one or more individual time gaps associated with the one or more L1 inter-frequency RSs. For example, referring to FIG. 11A, the at least one L1 measurement gap may include one or more individual time gaps (e.g., Gap 1, Gap 2, and Gap 3 may be considered as individual time gaps) associated with the one or more L1 inter-frequency RSs (e.g., RS 1, RS 2, and RS 3). In some aspects, 1412 may be performed by the measurement gap configuration component 198.

In some aspects, each of the one or more individual time gaps may be respectively configured for one L1 inter-frequency RS of the one or more L1 inter-frequency RSs. For example, referring to FIG. 11A, each of the one or more individual time gaps (e.g., Gap 1, Gap 2, and Gap 3) may be respectively configured for one L1 inter-frequency RS of the one or more L1 inter-frequency RSs (e.g., Gap 1 for RS 1, Gap 2 for RS 2, and Gap 3 for RS 3).

In some aspects, the one or more individual time gaps may have the same gap length. For example, referring to FIG. 11B, the one or more individual time gaps (e.g., the gaps associated with RS 1, RS 2, and RS 3) have the same gap length (e.g., the length of Gap 1).

In some aspects, the one or more individual time gaps may include one individual time gap configured for the one or more L1 inter-frequency RSs. For example, referring to FIG. 11C, the one or more individual time gaps may include one individual time gap (e.g., Gap 1) configured for the one or more L1 inter-frequency RSs (e.g., Gap 1 is configured to RS 1, RS 2, and RS 3).

In some aspects, each of the one or more individual time gaps may be configured for at least one of a frequency band of one or more frequency bands associated with the one or more L1 inter-frequency RSs or an SCS of multiple SCSs associated with the one or more L1 inter-frequency RSs. For example, referring to FIG. 11A, the one or more individual time gaps (e.g., Gap 1, Gap 2, and Gap 3) may be configured for at least one of a frequency band of one or more frequency bands associated with the one or more L1 inter-frequency RSs (e.g., RS 1, RS 2, and RS 3) or an SCS of multiple SCSs associated with the one or more L1 inter-frequency RSs (e.g., RS 1, RS 2, and RS 3).

In some aspects, time locations of the one or more individual time gaps may be associated with a network entity or derived by the UE based on the one or more L1 inter-frequency RSs. The time locations of the one or more individual time gaps may include one or more of: a set of gap time offsets of the one or more individual time gaps and a set of gap periodicities of the one or more individual time gaps. For example, referring to FIGS. 12 and 11A, time locations of the one or more individual time gaps (e.g., Gap 1, Gap 2, and Gap 3) may be associated with a network entity (base station 1204) or derived by the UE 1202 based on the one or more L1 inter-frequency RSs (e.g., RS 1, RS 2, and RS 3). The time locations of the one or more individual time gaps (e.g., Gap 1, Gap 2, and Gap 3) may include one or more of: a set of gap time offsets of the one or more individual time gaps (e.g., the gap time offsets for Gap 1, Gap 2, and Gap 3); and a set of gap periodicities of the one or more individual time gaps (e.g., the gap periodicities for Gap 1, Gap 2, and Gap 3). In some aspects, to obtain the indication including the one or more L1 inter-frequency RSs for the LTM, the UE may be configured to: receive, from a network entity, the indication including the one or more L1 inter-frequency RSs for the LTM. For example, referring to FIG. 12, to obtain the indication including the one or more L1 inter-frequency RSs for the LTM, the UE 1202 may be configured to receive, from a network entity (base station 1204), the indication including the one or more L1 inter-frequency RSs for the LTM (at 1206).

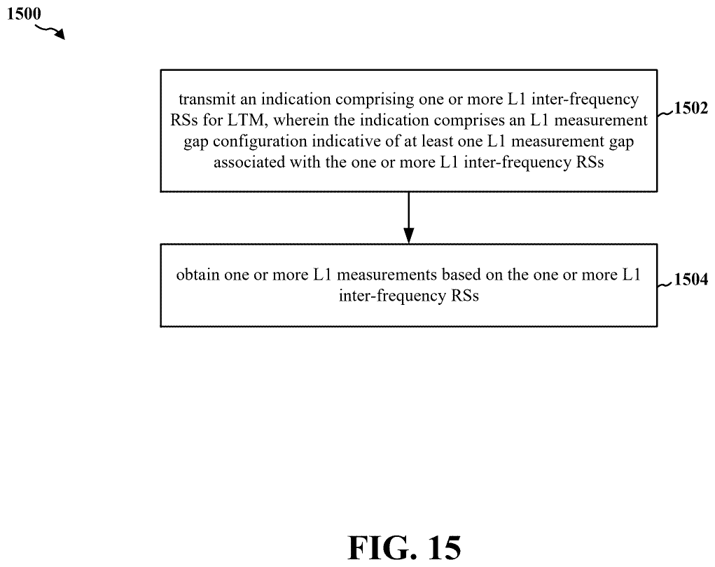

FIG. 15 is a flowchart 1500 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1204; or the network entity 1702 in the hardware implementation of FIG. 17). The method enables various measurement gap configurations for inter-frequency RS for LTM. It enhances the flexibility of inter-frequency LTM measurements and improves the efficiency of wireless communication.

As shown in FIG. 15, at 1502, the network entity may transmit an indication including one or more L1 inter-frequency RSs for LTM. The indication may include an L1 measurement gap configuration indicative of at least one L1 measurement gap associated with the one or more L1 inter-frequency RSs. The UE may be the UE 104, 350, 1202, or the apparatus 1704 in the hardware implementation of FIG. 17. FIGS. 9, 10A, 10B, 11A, 11B, 11C, and 12 illustrate various aspects of the steps in connection with flowchart 1500. For example, referring to FIG. 12, the network entity (base station 1204) may transmit, at 1206, an indication including one or more L1 inter-frequency RSs for LTM. The indication may include an L1 measurement gap configuration indicative of at least one L1 measurement gap associated with the one or more L1 inter-frequency RSs. Referring to FIG. 11A, the indication may include one or more L1 inter-frequency RSs for LTM (e.g., RS 1, RS 2, and RS 3), and the indication may include an L1 measurement gap configuration indicative of at least one L1 measurement gap (e.g., Gap 1, Gap 2, and Gap 3) associated with the one or more L1 inter-frequency RSs (e.g., RS 1, RS 2, and RS 3). Referring to FIG. 11C, the indication may include an L1 measurement gap configuration indicative of at least one L1 measurement gap (e.g., Gap 1) associated with the one or more L1 inter-frequency RSs (e.g., RS 1, RS 2, and RS 3). In some aspects, 1502 may be performed by the measurement gap configuration component 199.

At 1504, the network entity may obtain one or more L1 measurements based on the one or more L1 inter-frequency RSs. For example, referring to FIG. 12, the network entity (base station 1204) may obtain, at 1210, one or more L1 measurements based on the one or more L1 inter-frequency RSs. In some aspects, 1504 may be performed by the measurement gap configuration component 199.

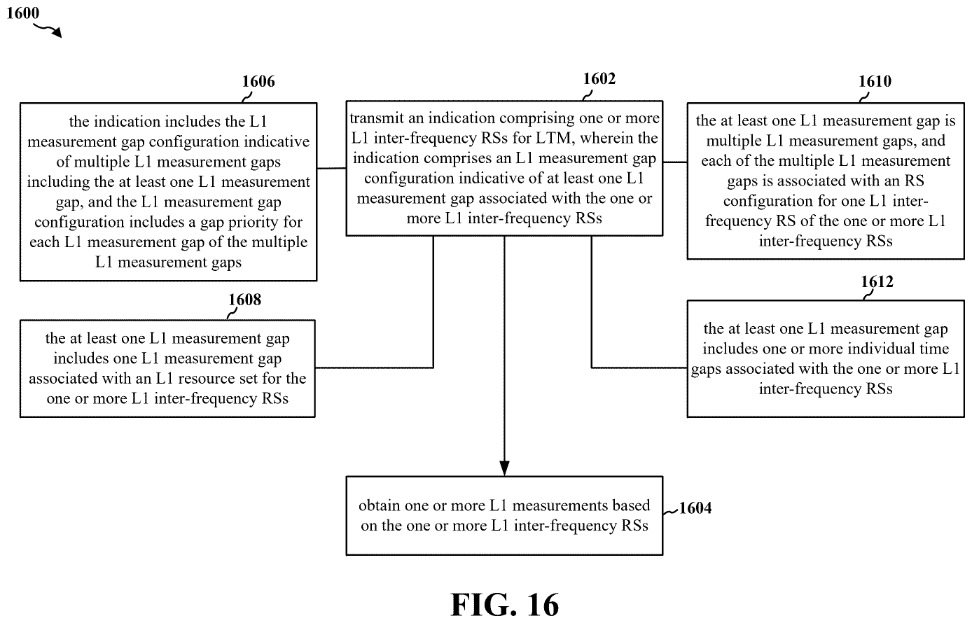

FIG. 16 is a flowchart 1600 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1204; or the network entity 1702 in the hardware implementation of FIG. 17). The method enables various measurement gap configurations for inter-frequency RS for LTM. It enhances the flexibility of inter-frequency LTM measurements and improves the efficiency of wireless communication.

As shown in FIG. 16, at 1602, the network entity may transmit an indication including one or more L1 inter-frequency RSs for LTM. The indication may include an L1 measurement gap configuration indicative of at least one L1 measurement gap associated with the one or more L1 inter-frequency RSs. The UE may be the UE 104, 350, 1202, or the apparatus 1704 in the hardware implementation of FIG. 17. FIGS. 9, 10A, 10B, 11A, 11B, 11C, and 12 illustrate various aspects of the steps in connection with flowchart 1600. For example, referring to FIG. 12, the network entity (base station 1204) may transmit, at 1206, an indication including one or more L1 inter-frequency RSs for LTM. The indication may include an L1 measurement gap configuration indicative of at least one L1 measurement gap associated with the one or more L1 inter-frequency RSs. Referring to FIG. 11A, the indication may include one or more L1 inter-frequency RSs for LTM (e.g., RS 1, RS 2, and RS 3), and the indication may include an L1 measurement gap configuration indicative of at least one L1 measurement gap (e.g., Gap 1, Gap 2, and Gap 3) associated with the one or more L1 inter-frequency RSs (e.g., RS 1, RS 2, and RS 3). Referring to FIG. 11C, the indication may include an L1 measurement gap configuration indicative of at least one L1 measurement gap (e.g., Gap 1) associated with the one or more L1 inter-frequency RSs (e.g., RS 1, RS 2, and RS 3). In some aspects, 1602 may be performed by the measurement gap configuration component 199.

At 1604, the network entity may obtain one or more L1 measurements based on the one or more L1 inter-frequency RSs. For example, referring to FIG. 12, the network entity (base station 1204) may obtain, at 1210, one or more L1 measurements based on the one or more L1 inter-frequency RSs. In some aspects, 1604 may be performed by the measurement gap configuration component 199.

In some aspects, the L1 measurement gap configuration may be based on an L3 measurement gap configuration, and the L1 measurement gap configuration may include one or more of a gap length for the at least one L1 measurement gap; a gap time offset for the at least one L1 measurement gap; a gap periodicity for the at least one L1 measurement gap; and a gap ID for the at least one L1 measurement gap. For example, referring to FIG. 9, the L1 measurement gap configuration may include one or more of: the gap length (e.g., mgl) for the at least one L1 measurement gap; the gap time offset (e.g., gapOffset) for the at least one L1 measurement gap; the gap periodicity (e.g., mgrp) for the at least one L1 measurement gap; and the gap ID (e.g., Associated-Gap-Id 910) for the at least one L1 measurement gap.

In some aspects, at 1606, the indication may include the L1 measurement gap configuration indicative of multiple L1 measurement gaps including the at least one L1 measurement gap, and the L1 measurement gap configuration may include a gap priority for each L1 measurement gap of the multiple L1 measurement gaps. For example, referring to FIG. 10B, the indication may include the L1 measurement gap configuration indicative of multiple L1 measurement gaps (e.g., Gap 1 and Gap 2), and the L1 measurement gap configuration may include a gap priority for each L1 measurement gap of the multiple L1 measurement gaps (e.g., the priority for Gap 1 and the priority for Gap 2). In some aspects, 1606 may be performed by the measurement gap configuration component 199.

In some aspects, at 1608, the at least one L1 measurement gap may include one L1 measurement gap associated with an L1 resource set for the one or more L1 inter-frequency RSs. For example, referring to FIG. 9, the at least one L1 measurement gap (e.g., the gap referenced by Associated-Gap-Id 910) may include one L1 measurement gap associated with an L1 resource set (e.g., the CSI-SSB-ResourceSet 908) for the one or more L1 inter-frequency RSs (e.g., RS 0, RS 1, . . . , RS N−1). In some aspects, 1608 may be performed by the measurement gap configuration component 199.

In some aspects, at 1610, the at least one L1 measurement gap may be multiple L1 measurement gaps, and each of the multiple L1 measurement gaps may be associated with an RS configuration for one L1 inter-frequency RS of the one or more L1 inter-frequency RSs. For example, referring to FIG. 11A, the at least one L1 measurement gap may include multiple L1 measurement gaps (e.g., Gap 1, Gap 2, and Gap 3), and each of the multiple L1 measurement gaps may be associated with an RS configuration for one L1 inter-frequency RS of the one or more L1 inter-frequency RSs (e.g., RS 1, RS 2, and RS 3). In some aspects, 1610 may be performed by the measurement gap configuration component 199.

In some aspects, each of the multiple L1 measurement gaps may be respectively associated with one gap ID of multiple gap IDs, and the multiple L1 measurement gaps may be associated with the same gap ID. For example, referring to FIG. 11B, each of the multiple L1 measurement gaps (e.g., gaps associated with RS 1, RS 2, and RS 3) may be respectively associated with one gap ID (e.g., the ID for Gap 1) of multiple gap IDs, and the multiple L1 measurement gaps (e.g., gaps associated with RS 1, RS 2, and RS 3) may be associated with the same gap ID (e.g., the ID for Gap 1).

In some aspects, each of the multiple L1 measurement gaps may be respectively associated with one gap ID of multiple gap IDs, and the multiple L1 measurement gaps may be associated with different gap IDs. For example, referring to FIG. 11A, each of the multiple L1 measurement gaps (e.g., gaps associated with RS 1, RS 2, and RS 3) may be respectively associated with one gap ID (e.g., IDs for Gap 1, Gap 2, and Gap 3) of multiple gap IDs, and the multiple L1 measurement gaps may be associated with different gap IDs (e.g., Gap 1 for the gap associated with RS 1, Gap 2 for the gap associated with RS 2, and Gap 3 for the gap associated with RS 3).

In some aspects, at 1612, the at least one L1 measurement gap may include one or more individual time gaps associated with the one or more L1 inter-frequency RSs. For example, referring to FIG. 11A, the at least one L1 measurement gap may include one or more individual time gaps (e.g., Gap 1, Gap 2, and Gap 3 may be considered as individual time gaps) associated with the one or more L1 inter-frequency RSs (e.g., RS 1, RS 2, and RS 3). In some aspects, 1612 may be performed by the measurement gap configuration component 199.

In some aspects, each of the one or more individual time gaps may be respectively configured for one L1 inter-frequency RS of the one or more L1 inter-frequency RSs. For example, referring to FIG. 11A, each of the one or more individual time gaps (e.g., Gap 1, Gap 2, and Gap 3) may be respectively configured for one L1 inter-frequency RS of the one or more L1 inter-frequency RSs (e.g., Gap 1 for RS 1, Gap 2 for RS 2, and Gap 3 for RS 3).

In some aspects, the one or more individual time gaps may have the same gap length. For example, referring to FIG. 11B, the one or more individual time gaps (e.g., the gaps associated with RS 1, RS 2, and RS 3) have the same gap length (e.g., the length of Gap 1).

In some aspects, the one or more individual time gaps may include one individual time gap configured for the one or more L1 inter-frequency RSs. For example, referring to FIG. 11C, the one or more individual time gaps may include one individual time gap (e.g., Gap 1) configured for the one or more L1 inter-frequency RSs (e.g., Gap 1 is configured to RS 1, RS 2, and RS 3).

In some aspects, each of the one or more individual time gaps may be configured for at least one of a frequency band of one or more frequency bands associated with the one or more L1 inter-frequency RSs or an SCS of multiple SCSs associated with the one or more L1 inter-frequency RSs. For example, referring to FIG. 11A, the one or more individual time gaps (e.g., Gap 1, Gap 2, and Gap 3) may be configured for at least one of a frequency band of one or more frequency bands associated with the one or more L1 inter-frequency RSs (e.g., RS 1, RS 2, and RS 3) or an SCS of multiple SCSs associated with the one or more L1 inter-frequency RSs (e.g., RS 1, RS 2, and RS 3).

In some aspects, time locations of the one or more individual time gaps may be configured by the network entity or based on the one or more L1 inter-frequency RSs, and the time locations of the one or more individual time gaps may include one or more of: a set of gap time offsets of the one or more individual time gaps and a set of gap periodicities of the one or more individual time gaps. For example, referring to FIGS. 12 and 11A, time locations of the one or more individual time gaps (e.g., Gap 1, Gap 2, and Gap 3) may be associated with a network entity (base station 1204) or derived by the UE 1202 based on the one or more L1 inter-frequency RSs (e.g., RS 1, RS 2, and RS 3). The time locations of the one or more individual time gaps (e.g., Gap 1, Gap 2, and Gap 3) may include one or more of: a set of gap time offsets of the one or more individual time gaps (e.g., the gap time offsets for Gap 1, Gap 2, and Gap 3) and a set of gap periodicities of the one or more individual time gaps (e.g., the gap periodicities for Gap 1, Gap 2, and Gap 3).

In some aspects, to transmit the indication including the one or more L1 inter-frequency RSs for the LTM, the network entity may be configured to: transmit, for a UE, the indication including the one or more L1 inter-frequency RSs for the LTM, and, to obtain the one or more L1 measurements based on the one or more L1 inter-frequency RSs, the network entity may be configured to: receive, from the UE, the one or more L1 measurements based on the one or more L1 inter-frequency RSs. For example, referring to FIG. 12, to transmit the indication including the one or more L1 inter-frequency RSs for the LTM, the network entity (base station 1204) may be configured to transmit, for a UE 1202, at 1206, the indication including the one or more L1 inter-frequency RSs for the LTM, and, to obtain the one or more L1 measurements based on the one or more L1 inter-frequency RSs, the network entity (base station 1204) may be configured to receive, at 1210, from the UE 1202, the one or more L1 measurements based on the one or more L1 inter-frequency RSs.

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see UE 350 of FIG. 3) and include the additional modules of the apparatus 1704.

As discussed supra, the component 198 may be configured to obtain an indication including one or more L1 inter-frequency RSs for LTM, where the indication includes an L1 measurement gap configuration indicative of at least one L1 measurement gap associated with the one or more L1 inter-frequency RSs; and perform one or more L1 measurements based on the one or more L1 inter-frequency RSs. The component 198 may be further configured to perform any of the aspects described in connection with the flowcharts in FIG. 13 and FIG. 14, and/or performed by the UE 1202 in FIG. 12. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for obtaining an indication including one or more L1 inter-frequency RSs for LTM, where the indication includes an L1 measurement gap configuration indicative of at least one L1 measurement gap associated with the one or more L1 inter-frequency RSs, and means for performing one or more L1 measurements based on the one or more L1 inter-frequency RSs. The apparatus 1704 may further include means for performing any of the aspects described in connection with the flowcharts in FIG. 13 and FIG. 14, and/or aspects performed by the UE 1202 in FIG. 12. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

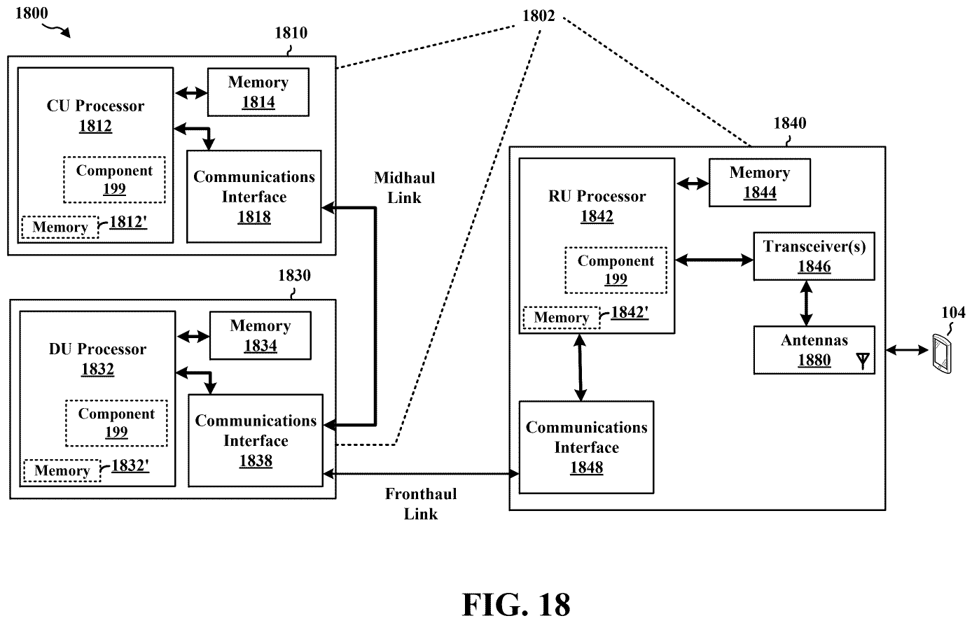

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit an indication including one or more L1 inter-frequency RSs for LTM, where the indication includes an L1 measurement gap configuration indicative of at least one L1 measurement gap associated with the one or more L1 inter-frequency RSs; and obtain one or more L1 measurements based on the one or more L1 inter-frequency RSs. The component 199 may be further configured to perform any of the aspects described in connection with the flowcharts in FIG. 15 and FIG. 16, and/or performed by the base station 1204 in FIG. 12. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for transmitting an indication including one or more L1 inter-frequency RSs for LTM, where the indication includes an L1 measurement gap configuration indicative of at least one L1 measurement gap associated with the one or more L1 inter-frequency RSs, and means for obtaining one or more L1 measurements based on the one or more L1 inter-frequency RSs. The network entity 1802 may further include means for performing any of the aspects described in connection with the flowcharts in FIG. 15 and FIG. 16, and/or aspects performed by the base station 1204 in FIG. 12. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include obtaining an indication including one or more L1 inter-frequency RSs for LTM, where the indication includes an L1 measurement gap configuration indicative of at least one L1 measurement gap associated with the one or more L1 inter-frequency RSs; and performing one or more L1 measurements based on the one or more L1 inter-frequency RSs. The method enables various measurement gap configurations for inter-frequency RS for LTM. It enhances the flexibility of inter-frequency LTM measurements and improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE. The method includes obtaining an indication including one or more L1 inter-frequency RSs for LTM, where the indication includes an L1 measurement gap configuration indicative of at least one L1 measurement gap associated with the one or more L1 inter-frequency RSs; and performing one or more L1 measurements based on the one or more L1 inter-frequency RSs.
Aspect 2 is the method of aspect 1, where the L1 measurement gap configuration may be based on an L3 measurement gap configuration, and the L1 measurement gap configuration may include one or more of: a gap length for the at least one L1 measurement gap, a gap time offset for the at least one L1 measurement gap, a gap periodicity for the at least one L1 measurement gap, and a gap ID for the at least one L1 measurement gap.
Aspect 3 is the method of aspect 2, where the indication may include the L1 measurement gap configuration indicative of multiple L1 measurement gaps including the at least one L1 measurement gap, and the L1 measurement gap configuration may include a gap priority for each L1 measurement gap of the multiple L1 measurement gaps.
Aspect 4 is the method of any of aspects 1 to 2, where the at least one L1 measurement gap may be one L1 measurement gap associated with an L1 resource set for the one or more L1 inter-frequency RSs.
Aspect 5 is the method of any of aspects 1 to 2, where the at least one L1 measurement gap may include multiple L1 measurement gaps, and each of the multiple L1 measurement gaps may be associated with an RS configuration for one L1 inter-frequency RS of the one or more L1 inter-frequency RSs.
Aspect 6 is the method of aspect 5, where each of the multiple L1 measurement gaps may be respectively associated with one gap ID of multiple gap IDs, and the multiple L1 measurement gaps may be associated with the same gap ID.
Aspect 7 is the method of aspect 5, where each of the multiple L1 measurement gaps may be respectively associated with one gap ID of multiple gap IDs, and the multiple L1 measurement gaps may be associated with different gap IDs.
Aspect 8 is the method of aspect 1, where the at least one L1 measurement gap may include one or more individual time gaps associated with the one or more L1 inter-frequency RSs.
Aspect 9 is the method of aspect 8, where each of the one or more individual time gaps may be respectively configured for one L1 inter-frequency RS of the one or more L1 inter-frequency RSs.
Aspect 10 is the method of aspect 8, where the one or more individual time gaps may have the same gap length.
Aspect 11 is the method of aspect 8, where the one or more individual time gaps may include one individual time gap configured for the one or more L1 inter-frequency RSs.
Aspect 12 is the method of aspect 8, where each of the one or more individual time gaps may be configured for at least one of a frequency band of one or more frequency bands associated with the one or more L1 inter-frequency RSs or an SCS of multiple SCSs associated with the one or more L1 inter-frequency RSs.
Aspect 13 is the method of aspect 8, where time locations of the one or more individual time gaps may be associated with a network entity or derived by the UE based on the one or more L1 inter-frequency RSs. The time locations of the one or more individual time gaps may include one or more of: a set of gap time offsets of the one or more individual time gaps; and a set of gap periodicities of the one or more individual time gaps.
Aspect 14 is the method of any of aspects 1 to 13, where obtaining the indication including the one or more L1 inter-frequency RSs for the LTM may include: receiving, from a network entity, the indication including the one or more L1 inter-frequency RSs for the LTM.
Aspect 15 is an apparatus for wireless communication at a UE, including: a memory; and at least one processor coupled to the memory and, based at least in part on information stored in the memory, the at least one processor is configured to perform the method of any of aspects 1-14.
Aspect 16 is the apparatus of aspect 15, further including at least one of a transceiver or an antenna coupled to the at least one processor and configured to obtain the indication.
Aspect 17 is an apparatus for wireless communication including means for implementing the method of any of aspects 1-14.
Aspect 18 is a computer-readable medium (e.g., a non-transitory computer-readable medium) storing computer executable code, where the code when executed by a processor causes the processor to implement the method of any of aspects 1-14.
Aspect 19 is a method of wireless communication at a network entity. The method may include transmitting an indication including one or more L1 inter-frequency RSs for LTM, where the indication includes an L1 measurement gap configuration indicative of at least one L1 measurement gap associated with the one or more L1 inter-frequency RSs; and obtaining one or more L1 measurements based on the one or more L1 inter-frequency RSs.
Aspect 20 is the method of aspect 19, where the L1 measurement gap configuration may be based on an L3 measurement gap configuration, and the L1 measurement gap configuration may include one or more of: a gap length for the at least one L1 measurement gap; a gap time offset for the at least one L1 measurement gap; a gap periodicity for the at least one L1 measurement gap; and a gap ID for the at least one L1 measurement gap.
Aspect 21 is the method of aspect 20, where the indication may include the L1 measurement gap configuration indicative of multiple L1 measurement gaps including the at least one L1 measurement gap, and the L1 measurement gap configuration may include a gap priority for each L1 measurement gap of the multiple L1 measurement gaps.
Aspect 22 is the method of any of aspects 19 to 20, where the at least one L1 measurement gap may include one L1 measurement gap associated with an L1 resource set for the one or more L1 inter-frequency RSs.
Aspect 23 is the method of any of aspects 19 to 20, where the at least one L1 measurement gap may include multiple L1 measurement gaps, and each of the multiple L1 measurement gaps may be associated with an RS configuration for one L1 inter-frequency RS of the one or more L1 inter-frequency RSs.
Aspect 24 is the method of aspect 23, where each of the multiple L1 measurement gaps may be respectively associated with one gap ID of multiple gap IDs, and the multiple L1 measurement gaps may be associated with the same gap ID.
Aspect 25 is the method of aspect 23, where each of the multiple L1 measurement gaps may be respectively associated with one gap ID of multiple gap IDs, and the multiple L1 measurement gaps may be associated with different gap IDs
Aspect 26 is the method of aspect 19, where the at least one L1 measurement gap may include one or more individual time gaps associated with the one or more L1 inter-frequency RSs.
Aspect 27 is the method of aspect 26, where each of the one or more individual time gaps may be respectively configured for one L1 inter-frequency RS of the one or more L1 inter-frequency RSs.
Aspect 28 is the method of aspect 26, where the one or more individual time gaps may have the same gap length.
Aspect 29 is the method of aspect 26, where the one or more individual time gaps may include one individual time gap configured for the one or more L1 inter-frequency RSs.
Aspect 30 is the method of aspect 26, where each of the one or more individual time gaps may be configured for at least one of a frequency band of one or more frequency bands associated with the one or more L1 inter-frequency RSs or a SCS of multiple SCSs associated with the one or more L1 inter-frequency RSs.
Aspect 31 is the method of aspect 26, where time locations of the one or more individual time gaps may be configured by the network entity or based on the one or more L1 inter-frequency RSs. The time locations of the one or more individual time gaps may include one or more of: a set of gap time offsets of the one or more individual time gaps; and a set of gap periodicities of the one or more individual time gaps.
Aspect 32 is the method of any of aspects 19 to 31, where transmitting the indication including the one or more L1 inter-frequency RSs for the LTM may include: transmitting, for a UE, the indication including the one or more L1 inter-frequency RSs for the LTM, and obtaining the one or more L1 measurements based on the one or more L1 inter-frequency RSs may include: receiving, from the UE, the one or more L1 measurements based on the one or more L1 inter-frequency RSs.
Aspect 33 is an apparatus for wireless communication at a network entity, including: a memory; and at least one processor coupled to the memory and, based at least in part on information stored in the memory, the at least one processor is configured to perform the method of any of aspects 19-32.
Aspect 34 is the apparatus of aspect 33, further including at least one of a transceiver or an antenna coupled to the at least one processor and configured to transmit the indication.
Aspect 35 is an apparatus for wireless communication including means for implementing the method of any of aspects 19-32.
Aspect 36 is a computer-readable medium (e.g., a non-transitory computer-readable medium) storing computer executable code, where the code when executed by a processor causes the processor to implement the method of any of aspects 19-32.

1. An apparatus for wireless communication at a user equipment (UE), comprising:
memory; and
at least one processor coupled to the memory and, based at least in part on information stored in the memory, the at least one processor is configured to:
obtain an indication comprising one or more layer 1 (L1) inter-frequency reference signals (RSs) for lower-layer triggered mobility (LTM), wherein the indication comprises an L1 measurement gap configuration indicative of at least one L1 measurement gap associated with the one or more L1 inter-frequency RSs; and
perform one or more L1 measurements based on the one or more L1 inter-frequency RSs.

2. The apparatus of claim 1, further comprising a transceiver coupled to the at least one processor, wherein, to obtain the indication, the at least one processor is configured to obtain the indication via the transceiver, and wherein the L1 measurement gap configuration is based on a layer 3 (L3) measurement gap configuration, and the L1 measurement gap configuration includes one or more of:
a gap length for the at least one L1 measurement gap;
a gap time offset for the at least one L1 measurement gap;
a gap periodicity for the at least one L1 measurement gap; and
a gap identifier (ID) for the at least one L1 measurement gap.

3. The apparatus of claim 2, wherein the indication comprises the L1 measurement gap configuration indicative of multiple L1 measurement gaps including the at least one L1 measurement gap, and wherein the L1 measurement gap configuration includes a gap priority for each L1 measurement gap of the multiple L1 measurement gaps.

4. The apparatus of claim 2, wherein the at least one L1 measurement gap is one L1 measurement gap associated with an L1 resource set for the one or more L1 inter-frequency RSs.

5. The apparatus of claim 2, wherein the at least one L1 measurement gap includes multiple L1 measurement gaps, and wherein each of the multiple L1 measurement gaps is associated with an RS configuration for one L1 inter-frequency RS of the one or more L1 inter-frequency RSs.

6. The apparatus of claim 5, wherein each of the multiple L1 measurement gaps is respectively associated with one gap ID of multiple gap IDs, and wherein the multiple L1 measurement gaps are associated with a same gap ID.

7. The apparatus of claim 5, wherein each of the multiple L1 measurement gaps is respectively associated with one gap ID of multiple gap IDs, and wherein the multiple L1 measurement gaps are associated with different gap IDs.

8. The apparatus of claim 1, wherein the at least one L1 measurement gap comprises one or more individual time gaps associated with the one or more L1 inter-frequency RSs.

9. The apparatus of claim 8, wherein each of the one or more individual time gaps is respectively configured for one L1 inter-frequency RS of the one or more L1 inter-frequency RSs.

10. The apparatus of claim 8, wherein the one or more individual time gaps have a same gap length.

11. The apparatus of claim 8, wherein the one or more individual time gaps include one individual time gap configured for the one or more L1 inter-frequency RSs.

12. The apparatus of claim 8, wherein each of the one or more individual time gaps is configured for at least one of a frequency band of one or more frequency bands associated with the one or more L1 inter-frequency RSs or a subcarrier spacing (SCS) of multiple SCSs associated with the one or more L1 inter-frequency RSs.

13. The apparatus of claim 8, wherein time locations of the one or more individual time gaps are associated with a network entity or derived by the UE based on the one or more L1 inter-frequency RSs, and wherein the time locations of the one or more individual time gaps comprise one or more of:
a set of gap time offsets of the one or more individual time gaps; and
a set of gap periodicities of the one or more individual time gaps.

14. The apparatus of claim 1, wherein, to obtain the indication comprising the one or more L1 inter-frequency RSs for the LTM, the at least one processor is configured to:
receive, from a network entity, the indication comprising the one or more L1 inter-frequency RSs for the LTM.

15. An apparatus for wireless communication at a network entity, comprising:
memory; and
at least one processor coupled to the memory and, based at least in part on information stored in the memory, the at least one processor is configured to:
transmit an indication comprising one or more layer 1 (L1) inter-frequency reference signals (RSs) for lower-layer triggered mobility (LTM), wherein the indication comprises an L1 measurement gap configuration indicative of at least one L1 measurement gap associated with the one or more L1 inter-frequency RSs; and
obtain one or more L1 measurements based on the one or more L1 inter-frequency RSs.

16. The apparatus of claim 15, further comprising a transceiver coupled to the at least one processor, wherein, to transmit the indication, the at least one processor is configured to transmit the indication via the transceiver, and wherein the L1 measurement gap configuration is based on a layer 3 (L3) measurement gap configuration, and the L1 measurement gap configuration includes one or more of:
a gap length for the at least one L1 measurement gap;
a gap time offset for the at least one L1 measurement gap;
a gap periodicity for the at least one L1 measurement gap; and
a gap identifier (ID) for the at least one L 1 measurement gap.

17.-21. (canceled)

22. The apparatus of claim 15, wherein the at least one L1 measurement gap comprises one or more individual time gaps associated with the one or more L1 inter-frequency RSs.

23.-26. (canceled)

27. The apparatus of claim 22, wherein time locations of the one or more individual time gaps are configured by the network entity or based on the one or more L1 inter-frequency RSs, and wherein the time locations of the one or more individual time gaps comprise one or more of:
a set of gap time offsets of the one or more individual time gaps; and
a set of gap periodicities of the one or more individual time gaps.

28. The apparatus of claim 15, wherein, to transmit the indication comprising the one or more L1 inter-frequency RSs for the LTM, the at least one processor is configured to:
transmit, for a user equipment (UE), the indication comprising the one or more L1 inter-frequency RSs for the LTM, and wherein, to obtain the one or more L1 measurements based on the one or more L1 inter-frequency RSs, the at least one processor is configured to:
receive, from the UE, the one or more L1 measurements based on the one or more L1 inter-frequency RSs.

29. A method of wireless communication at a user equipment (UE), comprising:
obtaining an indication comprising one or more layer 1 (L1) inter-frequency reference signals (RSs) for lower-layer triggered mobility (LTM), wherein the indication comprises an L1 measurement gap configuration indicative of at least one L1 measurement gap associated with the one or more L1 inter-frequency RSs; and
performing one or more L1 measurements based on the one or more L1 inter-frequency RSs.

30. (canceled)
